(19) United States
(12) Patent Application Publication
(10) Pub. No.: US 2006/0101663 A1
(43) Pub. Date: May 18, 2006

(54) Lumber drying

(76) Inventors: Nolan A. Perin, Pen Argyl, PA (US); Richard A. Peluso, Cambell Hall, NY (US)

Correspondence Address: LAW OFFICES OF ARTHUR E. JACKSON, P.O. BOX 88, HOPEWELL, NJ, 08525, US

(21) Appl. No.: 11/269,151

(22) Filed: Nov. 8, 2005

Related U.S. Application Data
(60) Provisional application No. 60/626,037, filed on Nov. 8, 2004.

(51) Int. Cl. F26B 19/00; F26B 7/00

(52) U.S. Cl. 34/396; 34/86

(57) ABSTRACT

Provided, among other things, is a method of drying lumber comprising: igniting landfill gas to directly or indirectly create a heated gas or heat exchange medium; and directing the heated gas into an enclosure containing lumber to be dried or directing the heat exchange medium into a heat exchanger located within the enclosure.

This application claims the priority of U.S. Provisional Application 60/626,037, filed on Nov. 8, 2004.

The present invention relates to methods and devices for drying lumber.

Combustible gases are produced by landfills. The quality of this gas as an energy source varies, for example with the age of the landfill or with the placement of the source collection wells. Where the energy content is 460 BTU/ft³ or higher, it may be practical to operate electricity producing turbines or engines. Lower energy content gas or gas that is not produced in sufficient quantity to make energy production practical is often ignited in a flare to reduce its noxious odor content and/or to reduce pollutants from entering the atmosphere.

Because there has been a use for higher quality landfill gas, little attention has been paid to secondary uses for the heat provided by burning the gas. Because the focus for lower quality gas has been on odor reduction, little attention has been paid to uses compatible with its low energy content. Similarly, where landfills produce insufficient quality gas for energy production, little attention has been paid to uses compatible with its low energy content. Thus, it has not been recognized that landfill gas provides an excellent, cost effective source of heat for drying lumber.

### SUMMARY OF THE INVENTION

In one embodiment, the invention provides a method of drying lumber comprising: igniting landfill gas to directly or indirectly create a heated gas or heat exchange medium; and directing the heated gas into an enclosure containing lumber to be dried or directing the heat exchange medium into a heat exchanger located within the enclosure.

In another embodiment the invention provides a lumber drying plant comprising: a kiln adapted to dry lumber; and a heater for the kiln comprising one or more of:
an electric generation turbine or engine adapted to be fueled with landfill gas and cooled with a second heat exchange medium, and means to heat the kiln with the second heat exchange medium when heated by the engine, or
a furnace adapted to be fueled by landfill gas and to heat a third heat exchange medium, and means to heat the kiln with the third heat exchange medium when heated by the furnace.

In still another embodiment, the invention provides a lumber drying plant comprising: a kiln adapted to dry lumber; a flare adapted to combust landfill gas; and a heater for the kiln comprising one or more of:
a flare heat exchanger adapted to collect heat from the flare into a heat exchange medium, and means to heat the kiln with the heated heat exchange medium, or
an electric generation turbine or engine adapted to be fueled with landfill gas and cooled with a second heat exchange medium, and means to heat the kiln with the second heat exchange medium when heated by the turbine or engine, or
a furnace adapted to be fueled by landfill gas and to heat a third heat exchange medium, and means to heat the kiln with the third heat exchange medium when heated by the furnace.
   In some embodiments, the plant has plumbing adapted to direct the atmosphere from the kiln to the flare. The “second” heat exchange medium can be given a different identifier, such as “generator” heat exchange medium. Similarly, the “third” heat exchange medium can be identified, for example, as the “furnace” heat exchange medium.

In another embodiment the invention provides a lumber drying plant comprising: a kiln adapted to dry lumber; heat exchange piping within the kiln; and conduits adapted to be stacked within the lumber and quick release couple to the heat exchange piping.

### BRIEF DESCRIPTION OF THE DRAWINGS

FIGS. 1-5 show various illustrative wood-drying plants.

### DETAILED DESCRIPTION OF THE INVENTION

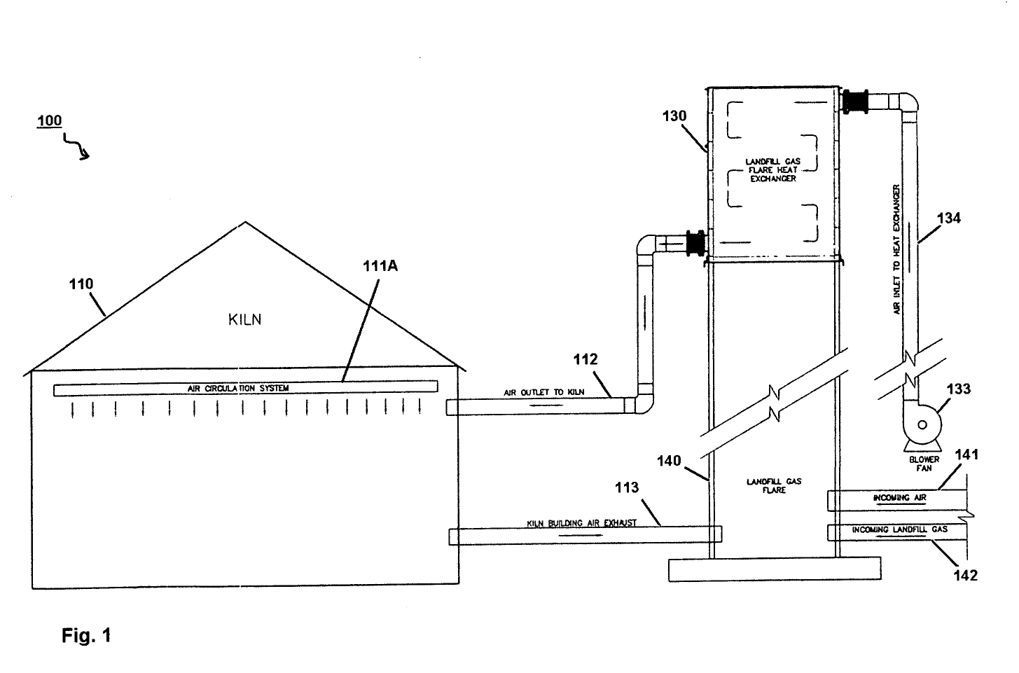

Shown in FIG. 1 is an illustrative wood-drying plant 100. Kiln 110 receives heated gas through klin-inlet pipe 112. An optional air circulation system 111A (e.g., ducts and baffles, blowers, and the like) distributes heated air through the kiln 110. In the illustrated embodiment, air is directed into flare heat exchanger 130 by blower 133 and heat exchanger-inlet pipe 134. The heat exchanger 130 exchanges heat from flare 140, which is fueled from air inlet 141 and landfill gas inlet 142. Optionally, kiln-outlet pipe 113 directs exhaust from the kiln 110 to the flare 140, thereby reducing Volatile Organic Compounds (VOC) in the kiln exhaust.

It should be recognized that the air circulation system of wood-drying plant 100 can be replaced by a kiln heat exchange system, such as a system of baffled conduits that radiate heat. Accordingly, the heated fluid provided by the flare heat exchanger 130 can be gas or another heat exchange medium. If a kiln heat exchanger is used with heated gas from a flare heat exchanger, this heat exchange medium can be directly exhausted (not shown), or exhausted into the kiln exhaust with other gases from the kiln. Since the atmosphere in the kiln should be exchanged as its water content increases, the gas from the flare heat exchanger can provide fresh atmosphere that may not require as much heating as might external air.

The combusted gas of the flare itself can be used directly to provide the heat and atmosphere for the kiln.

The flare heat exchanger can serve to add to the detention time of combustible molecules in the combustion zone of a flare. Thus, the flare heat exchanger can, in addition to providing heat for drying lumber, increase the environmental quality of the landfill's gas byproduct.

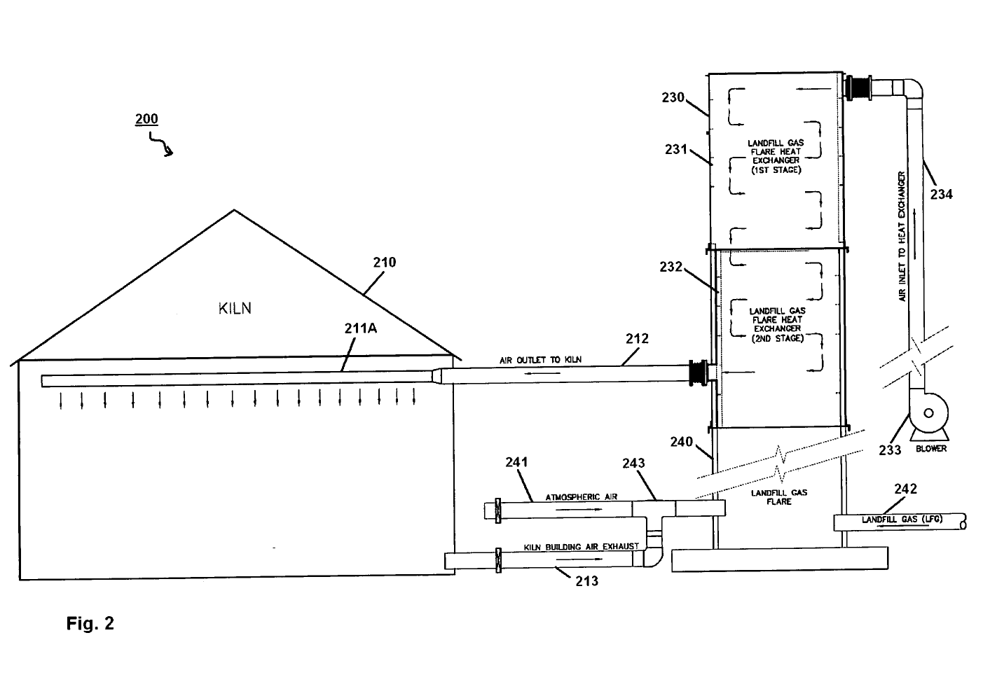

As shown in the illustrative wood-drying plant 200 of FIG. 2, kiln-outlet pipe 213 is joined to air inlet 241 at junction 243. Hardware can be provided such that, for example, all of the kiln-outlet gas is consumed in the flare, supplemented with atmosphere as needed. The heat exchanger 230 can have, for example, an upper segment 231 of heat exchange piping located above the flare 240, and a lower segment 232 that provides heat exchange piping about the periphery of the flare 240. (Elements in different figures numbered with the same last two digits and, if present, last letter, are analogous to one another; and hence are not redundantly named here.)

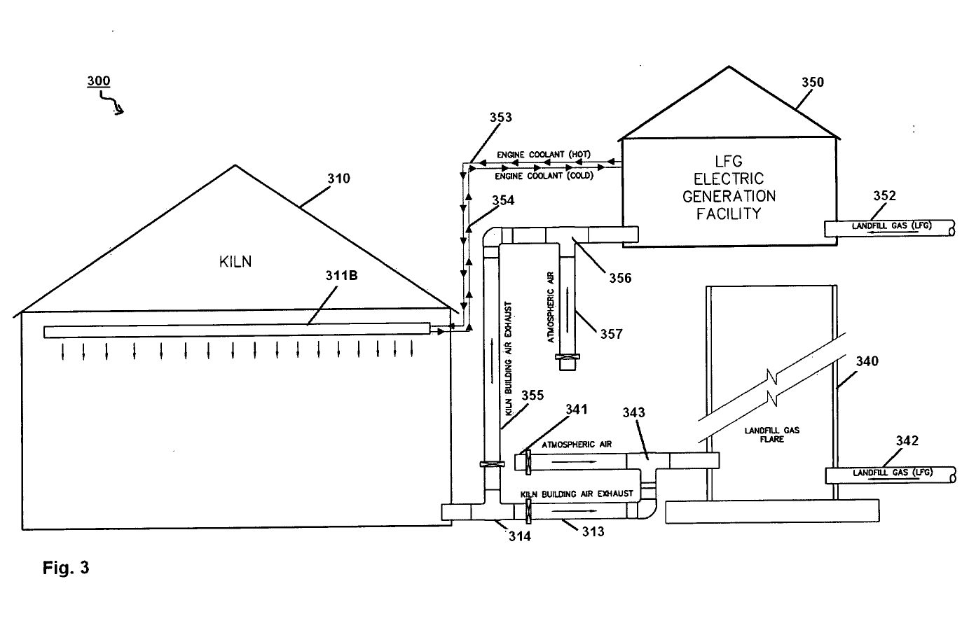

In another embodiment, illustrative wood-drying plant 300 (FIG. 3) acquires heat from the coolant used in the generator turbines or engines of a landfill gas to electric generation facility 350. Heated coolant is delivered to heat exchanger 311B with outlet pipes 353, then returned with inlet pipes 354. Landfill gas is provided to the turbines or engines via landfill gas inlet 352. Exhaust from the kiln can be optionally delivered to the turbines or engines with exhaust inlet 355, which in this illustration is joined to kiln-outlet pipe 313 at junction 314. Kiln outlet pipe 3313 is, for example, joined to air inlet 341 at junction 343. Hardware can be provided such that, for example, all of the kiln-outlet gas is consumed in the turbines or engines, supplemented with atmosphere from air inlet 357 (joined at junction 356) as needed. Hardware, and optionally automation tools, can be provided so that kiln-outlet gas is directed to flare 330 when or to the extent landfill gas to electric generation facility 350 is not available to consume that gas.

The flare can be operated concurrently with the landfill gas to electric generation facility, for example using gas from wells producing lower quality gas. Thus, in embodiments in which VOCs from the kiln are combusted, in some such embodiments these VOCs are combusted solely or primarily in the flare.

It should be recognized that flare 340 (or any other flare) can be fitted with heat exchanger that can provide heated gas or other heat exchange medium to the kiln. Where a flare is used in conjunction with a landfill gas to electric generation facility, it can be the primary heat source for the kiln, a supplemental heat source, or, as in FIG. 3, a non-contributor to kiln heat.

The engines (typically diesel) or turbines used in a landfill gas to electric generation facility typically do not well tolerate changes in rpms. Thus, fuel feed should be maintained at approximately the same rate and quality. Thus, the landfill gas to electric generation facility should be adapted to run at the rates provided at the troughs of the variations in a landfill's gas production. Of course, with the season and other variables, the rate may be adjusted by bringing engines on or off line. Nonetheless, an excess of gas is typically produced which may or may not be buffered by storage (though usually storage is impractical). Thus, a supplemental flare is often of additional use in combusting gas and thereby reducing odor. In some cases, odor reduction alone is not enough to motivate use of the flare. In these cases supplemental income from additional wood drying capacity and tax credits for energy production can provide further motives for cleaning the gas byproduct.

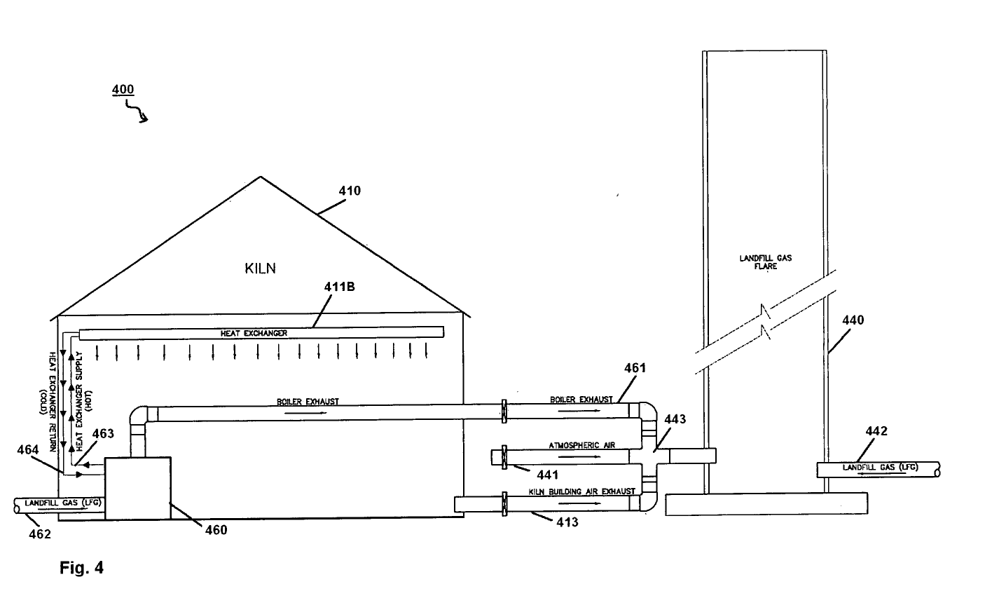

In a further embodiment, illustrative wood-drying plant 400 (FIG. 4) acquires heat from a furnace 460, fueled with landfill gas inlet 462. Heated heat exchange medium (such as steam) is delivered to heat exchanger 411B from furnace 460 (such as, without limitation a boiler) with outlet pipes 463, then returned with inlet pipes 464. Furnace exhaust 461 can be piped to junction 443. Furnace exhaust 461 can be directed on a path that conveys heat therein into the kiln 410. For example, the exhaust can be upwardly coiled through the kiln. The furnace is illustrated in a heat utilization-efficient location within the kiln, but this location is optional.

In this and other embodiments, the kiln heat exchanger can be replaced with an air circulation system, with the furnace operating to heat air or other gas as the heat exchange medium. “Air” in this and other embodiments can be replaced with another gas, though atmospheric air is typically the economical choice.

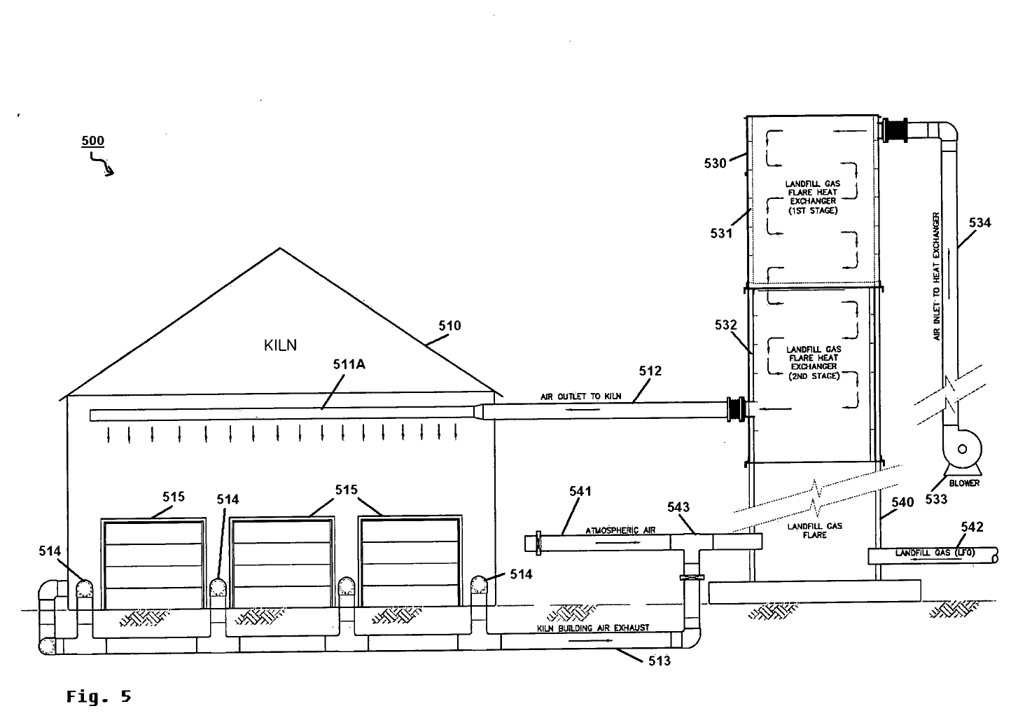

As illustrated in FIG. 5, kiln-outlet pipes 513 can manifold exhaust from multiple outlets 514. The manifolding can be done at a low level, such as below ground, to help collect cooler gas from the kiln 510. In this embodiment, as in the others, gas can be pushed through pipes as needed, such as by fan operated by control hardware. Doors 515 for inserting and removing lumber can be, for example, placed between outlets 514.

In certain embodiments, the landfill gas used has an energy content of 450 BTU/ft³ or less, 440 BTU/ft³ or less, 430 BTU/ft³ or less, 420 BTU/ft³ or less, 410 BTU/ft³ or less, or 400 BTU/ft³ or less.

In certain embodiments, combusted landfill gas is used directly to heat the lumber. In other embodiments, such combusted landfill gas is passed through a heat exchange arrangement and conveys heat to a second gas or other heat exchange medium. For example, the landfill gas may be combusted with excess oxygen provided to increase combustion efficiency. In some embodiments, the excess oxygen may not be desirable in the drying kiln. Thus, the combusted landfill gas can be used to heat another gas, such as one with lower oxygen content. A second gas can also have lower water content, increasing its effectiveness in drying lumber. Any gas to be used to fill the kiln can be passed through a condensing unit that lowers water content.

VOCs are generated by the drying process. However, in most instances the rate of generation is small enough that VOC do not raise substantial issues. As one option, however, the VOCs can be combusted catalytically or thermally, optionally using heat from the combustion of landfill gas.

In certain embodiments, the drying kiln is placed at or near the landfill. For example, the kiln is located close enough to the landfill to make piping the landfill gas to the kiln practical. For example, the kiln can be located 5 miles or less from the gas production at the landfill. Or, the kiln can be located 4 miles or less, 3 miles or less, 2 miles or less, 1 miles or less, 0.5 miles or less, from gas production. In certain embodiments, the gas and resulting heated gas are conveyed with conduit such as pipe, avoiding the use of storage tanks.

A further advantage of drying methods according to the invention is that within wide limits heated gas production can be generated and utilized at a rate matching the need to flare the landfill gas. With greater production, heated gas flow through the kiln is increased, thereby more uniformly distributing heat and drier air. At lower production rates, drying may not be as fast, but the process more efficiently utilizes the heat content of the landfill gas.

When stacked for drying the wood is typically separated by spacers, which can be pieces of the lumber to be dried, waste lumber, or another material. Drying can occur on a rack adapted for hoisting or carting in an out of the kiln. Lumber on such a rack will typically be stacked with supplemental spacers. To convey heat exchange medium more directly into the stack, some of the spacers or elements of the rack can be conduits for the heat exchange medium. Such conduits can be constructed of a heat-conductive material such as aluminum. The conduits can be adapted to quick-release couple to piping for heat exchange medium.

A “serpentine” pathway for an exhaust from a furnace is one that doubles (or more) the length of the direct pathway (within the kiln) from the furnace to the farthest wall of the kiln from the furnace.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

1. A method of drying lumber comprising:
igniting landfill gas to directly or indirectly create a heated gas or heat exchange medium; and
directing the heated gas into an enclosure containing lumber to be dried or directing the heat exchange medium into a heat exchanger located within the enclosure.

2. The method of claim 1, wherein the igniting directly or indirectly creates a heated gas.

3. The method of claim 2, wherein the ignited landfill gas provides the heated gas.

4. The method of claim 3, wherein the landfill gas, prior to ignition, had an energy content of 450 BTU/ft³ or less.

5. The method of claim 1, wherein the heat exchange medium (which may be a second gas) heated by the ignited landfill gas.

6. The method of claim 5, wherein the landfill gas, prior to ignition, had an energy content of 450 BTU/ft³ or less.

7. The method of claim 5, wherein the heat exchange medium is a coolant for electric generator turbines/engines and is heated by the generator turbines/engines.

8. The method of claim 5, wherein the heat exchange medium is heated by a furnace fueled with the landfill gas.

9. The method of claim 8, wherein the landfill gas, prior to ignition, had an energy content of 450 BTU/ft³ or less.

10. The method of claim 8, wherein exhaust from the furnace is serpentinely directed out of the enclosure.

11. The method of claim 1, further comprising:
circulating gas from the enclosure through an ignition of landfill gas, which ignition is optionally the ignition of the above igniting step.

12. The method of claim 1, wherein the lumber drying is conducted within 5 miles of a landfill that produces the landfill gas, and the landfill gas and heated gas are conveyed by conduit.

13. (canceled)

14. A lumber drying plant comprising:
a kiln adapted to dry lumber;
if a flare heat exchanger is present, a flare adapted to combust landfill gas; and
a heater for the kiln comprising one or more of:
the flare heat exchanger adapted to collect heat from the flare into a heat exchange medium, and means to heat the kiln with the heated heat exchange medium, or
an electric generation engine adapted to be fueled with landfill gas and cooled with a second heat exchange medium, and means to heat the kiln with the second heat exchange medium when heated by the engine, or
a furnace adapted to be fueled by landfill gas and to heat a third heat exchange medium, and means to heat the kiln with the third heat exchange medium when heated by the furnace.

15. The drying plant of claim 14, wherein the plant has plumbing adapted to direct at least a portion of atmosphere from the kiln to the flare.

16. A lumber drying plant comprising:
a kiln adapted to dry lumber;
heat exchange piping within the kiln; and
heat exchange conduits adapted to be stacked within the lumber and quick release couple to the heat exchange piping.
